(19) United States
(12) Patent Application Publication
(10) Pub. No.: US 2008/0132243 A1
(43) Pub. Date: Jun. 5, 2008

(54) DEVICE AND METHOD FOR PROVIDING LOCATION INFORMATION ON A PORTABLE MOBILE COMMUNICATIONS DEVICE

(75) Inventors: Karin Spalink, Durham, NC (US); Jeffery Jason Griffin, Raleigh, NC (US)

Correspondence Address: MOORE AND VAN ALLEN PLLC FOR SEMC, P.O. BOX 13706, 430 DAVIS DRIVE, SUITE 500, RESEARCH TRIANGLE PARK, NC, 27709, US

(73) Assignee: SONY ERICSSON MOBILE COMMUNICATIONS AB, LUND (SE)

(21) Appl. No.: 11/564,894

(22) Filed: Nov. 30, 2006

(51) Int. Cl. H04Q 7/20

(52) U.S. Cl. 455/456.1

(57) ABSTRACT

A portable mobile communications device and method of providing location data of other portable mobile communications devices as icons on a map display is presented. An area of interest is shown as a map on the portable mobile communications device display. An application determines the on-line presence status of one or more other users having similarly equipped portable mobile communications devices. The geographical location data of the other portable mobile communications devices currently on-line is obtained from the mobile phone network infrastructure and inserted as an icon on the map to accurately represent their actual geographic location. The user can select an icon on the map to change the display to show additional data pertaining to the geographic location represented by the icon. Or, the user can change the display to present options for contacting the user associated with the icon which can be automatically launched if selected.

### BACKGROUND OF THE INVENTION

Portable mobile communications devices such as mobile phones are becoming more sophisticated and include many new features and capabilities. Many portable mobile communications devices include location determining equipment such as, for instance, a GPS module, or the like. A Global Positioning System (GPS) module is designed to provide a precise position for a portable mobile communications device using satellite navigation systems. The precise position data determined by the GPS module in the portable mobile communications device can be uploaded to the mobile network infrastructure. Once uploaded it can be used in a variety of applications.

### BRIEF SUMMARY OF THE INVENTION

Disclosed is a portable mobile communications device, method, and computer program product that can provide location data of other portable mobile communications devices as icons on a map display. An area of interest is shown as a map on the portable mobile communications device display. An application determines the on-line presence status of one or more other users having similarly equipped portable mobile communications devices. The geographical location data of the other portable mobile communications devices currently on-line is obtained from the mobile phone network infrastructure and inserted as an icon on the map to accurately represent their actual geographic location. The user can select an icon on the map to change the display to show additional data pertaining to the geographic location represented by the icon. Or, the user can change the display to present options for contacting the user associated with the icon which can be automatically launched if selected.

### BRIEF DESCRIPTION OF THE DRAWINGS

FIG. 1 is an illustration of a portable mobile communications device in which the display is illustrating a sample map with icons to indicate the location of other mobile units associated with users of interest.

FIG. 2 is an illustration of a portable mobile communications device in which the display is illustrating a sample map of smaller scale with icons to indicate the location of other mobile units associated with users of interest.

FIG. 3 is an illustration of a portable mobile communications device in which the display is illustrating a list of other users stored in the contacts database, their on-line status, and their current location if on-line.

FIG. 4 is an illustration of a portable mobile communications device in which the display is illustrating a sample map of smaller scale with an icon to indicate the location of another mobile unit associated with a user of interest that was selected from a list like that illustrated in FIG. 3.

FIG. 5 is an illustration of a portable mobile communications device in which the display is illustrating additional information about a specific location.

FIG. 6 is an illustration of a portable mobile communications device in which the display is illustrating data on how to contact the user associated with a location of interest.

FIG. 7 is an illustration of a portable mobile communications device in which the display is illustrating the status of the selected means for contacting the user associated with a location of interest.

FIG. 8 is a system block diagram illustrating the interaction among the elements that affect the present invention.

FIG. 9 is a flowchart illustrating a method for providing location information for selected users having similarly equipped portable mobile communications devices.

FIG. 10 is a flowchart illustrating an alternate method for providing location information for selected users having similarly equipped portable mobile communications devices.

FIG. 11 is yet another flowchart illustrating an alternate method for providing location information for selected users having similarly equipped portable mobile communications devices.

### DETAILED DESCRIPTION OF THE INVENTION

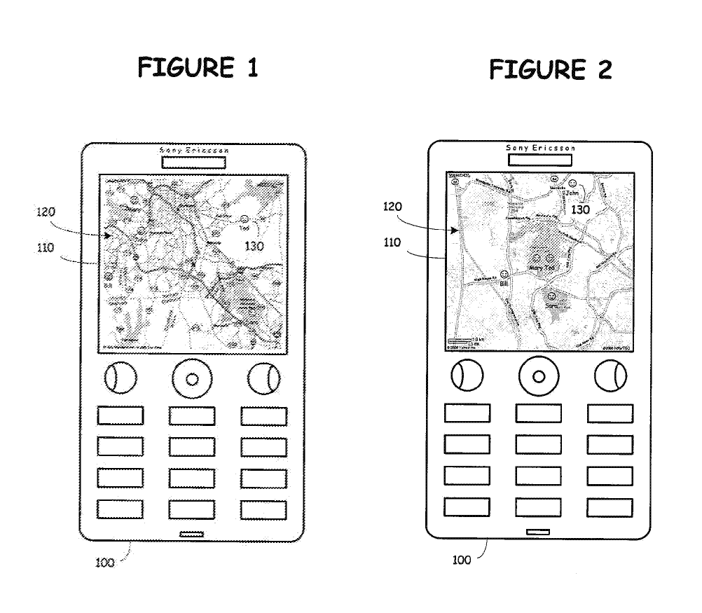

FIG. 1 is an illustration of a portable mobile communications device 100 in which the display 110 is illustrating a sample map 120 with icons 130 to indicate the location of other mobile units associated with users of interest. FIG. 2 is an illustration of a portable mobile communications device 100 in which the display 110 is illustrating a sample map 120 of smaller scale with icons 130 to indicate the location of other mobile units associated with users of interest. FIGS. 1 and 2 illustrate how a user can view location information pertaining to other users that have similarly equipped portable mobile communications devices. The difference between FIGS. 1 and 2 is the scale of the map. The user can manipulate the scale of the map to cover more or less area as desired. If the map covers a greater area there is a likelihood of having more icons on the display. The user can locate a particular icon and could ‘zoom’ in on that area of the map to see greater detail. This is somewhat demonstrated in the differences between FIGS. 1 and 2.

The list of users represented by the icons is pre-determined and can be manipulated. A user can identify persons stored as contacts in an internal contact database. One embodiment could employ an instant messaging type model in which a user establishes a ‘friends’ list of like minded and similarly equipped users. Each user can remain hidden (off-line) or available (on-line). If hidden their location data will be shielded from other users. If available their location data will be available to other users of the system. Each user can control their own status. In addition, the icons shown in the Figures are illustrative in nature. Individual icons or symbols can be uniquely created to represent specific other users. A user also has the discretion to add or delete other users from his personal friends list.

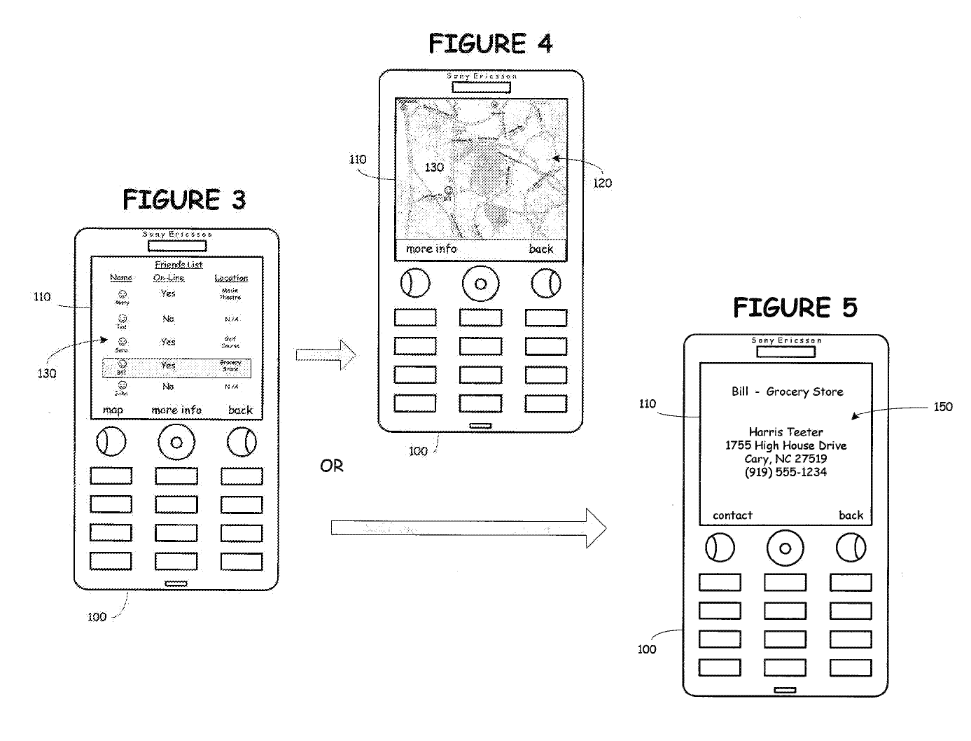

FIG. 3 is an illustration of a portable mobile communications device 100 in which the display 110 is illustrating a list 140 of other users stored in the contacts database, their on-line status, and their current location if on-line. In this example, the display 110 is illustrating a list 140 of five friends (Mary, Ted, Sara, Bill, and John), their current availability (on-line or off-line), and their current location (if on-line). The user can scroll through the list 140 to highlight and select one of the list entries corresponding to a friend. In this example the user has highlighted ‘Bill’. The user can select ‘Bill’ to obtain additional information about Bill's current location.

If Bill is selected from the list in FIG. 3, a map 120 (FIG. 4) will pop-up with an icon 130 to indicate the specific location of Bill on the map. This gives the user a graphical indication of Bill's location that he can put into a relevant context.

Another option available to the user is illustrated in FIG. 5 which is an illustration on the display 110 of additional information 150 about Bill's specific location. This can be obtained using address data associated with the coordinate location of Bill's portable mobile communications device. A database that links coordinate locations to addresses can be maintained within the network infrastructure and made available to users upon request from a location display application. Additional information about a specific location can include, but is not limited to, a generic name for the location, a specific name for the location, the street address of the location, and a telephone number for the location. The example shown in FIG. 5 indicates that Bill is currently at a grocery store called Harris Teeter located at 1755 High House Drive in Cary, N.C. 27519. The store's telephone number is 919-555-1234. This can be useful information to the user especially if he wishes to contact Bill in regards to his present location.

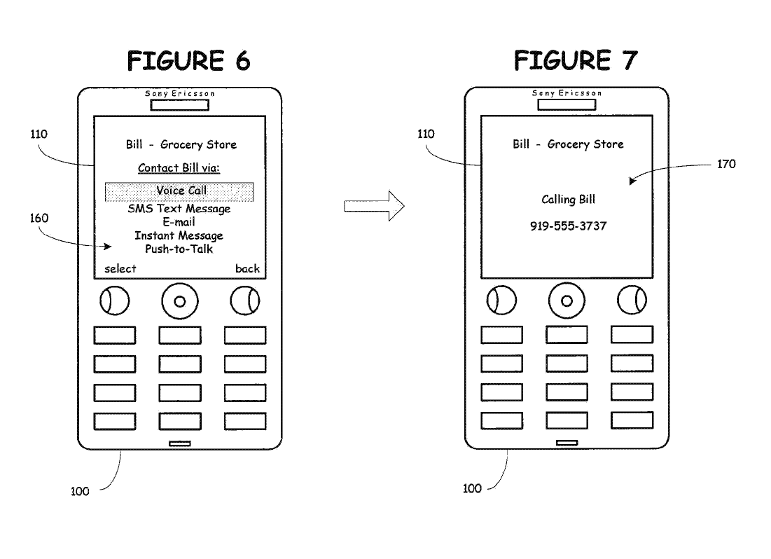

Suppose the user wishes to contact Bill based on the location information. FIG. 6 is an illustration of a portable mobile communications device 100 in which the display 110 is illustrating data 160 on how to contact Bill. The user can scroll through several modes of contact including, but not limited to, placing a voice call, sending an SMS text message, sending an e-mail, starting a text based instant messaging (IM) session, or establishing a push-to-talk voice connection. In this example, the user has chosen to contact Bill by making a voice call as indicated by the highlighted portion in FIG. 6. Upon pressing a key corresponding to ‘select’, the portable mobile communications device 100 will initiate a call with Bill. This is illustrated in FIG. 7 in which the display 110 shows the portable mobile communications device 100 dialing Bill's portable mobile communications device using data 170 obtained from the internal contact database.

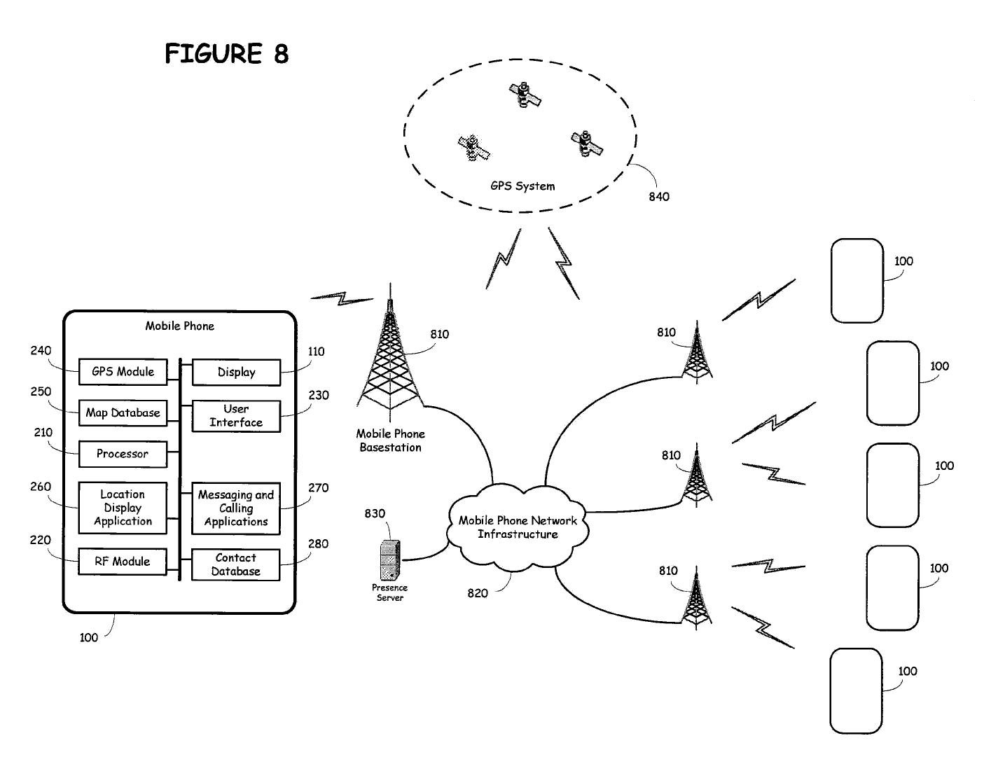

FIG. 8 is a system block diagram illustrating the interaction among the elements that affect the present invention. A portable mobile communications device 100 includes a display 110, a processor 210, an RF module 220, a user interface 230, a GPS module 240, a map database 250, a location display application 260, messaging and calling applications 270, and a contact database 280.

The processor 210 is responsible for operatively connecting the various other components such that relevant information can be obtained, processed, and forwarded to the relevant components, applications, and modules.

The RF module provides a wireless communication link with a mobile phone network infrastructure 820 via a mobile phone basestation 810. The RF module is responsible for sending and receiving voice and data communications to and from the mobile phone network infrastructure 820. The mobile phone network infrastructure 820, in turn, can be coupled to or with a variety of other communication networks (not shown) to allow for point-to-point communications between the portable mobile communications device 100 and other communication devices including, but not limited to, other portable mobile communications devices 100. Other communication networks include, but are not limited to, the public switched telephone network (PSTN), the Internet, satellite navigation systems, satellite television/radio systems, cable television/radio systems, or over-the-air television/radio systems. These other systems may, in turn, be communicable with still smaller localized communication systems such as, for instance, a WiFi network, to provide end-to-end communications between individual devices.

The user interface 230 can include components such as, for instance, a keypad, the display 110, other hard-wired buttons about the housing of the portable mobile communications device 100, navigational components like a joystick or a jog dial, voice controlled input, a touch screen for use with a stylus, or the like. The user interface 230 exists to aid the user in inputting data, navigating software applications and menu structures, selecting options, directing output, displaying images or data, etc.

GPS module 240 is communicable with a GPS System 840 orbiting the earth. The primary function of the GPS module 240 is to determine location coordinates that pinpoint the location of the portable mobile communications device 100 to a high degree of accuracy. The coordinate location data is then fed to the processor 210 where it can be further disseminated to other components, applications, and modules as needed or requested. The exact operation of the GPS module is beyond the scope of the present invention. The present invention is only interested in the fact that fairly precise location data of the portable mobile communications device 100 can be obtained and used by other components. Thus, the GPS system may not necessarily be the only location determination system employed by the present invention. The present invention can be made operable with other location determination systems without affecting the spirit or scope of the present invention.

The map database 250 is a repository of street maps covering a geographic area. The map database can be stored locally on the portable mobile communications device 100 or within the mobile phone network infrastructure 820 in an area easily accessible to the portable mobile communications device 100. Portions of the maps can be called up and displayed on the display 110 based on the position of one or more portable mobile communications devices 100. The user can then navigate north, south, east, and west as well as zoom in and out as desired.

The location display application 260 is the software that coordinates the functions described in the present invention. It is responsible for assisting the user in displaying location data corresponding to selected other users (friends) that are currently on-line. The location display application 260 also allows the user to toggle between maps and data about locations of friends as well as launching messaging and/or calling applications to contact friends of interest based on their current location. The location display application 260 obtains the location data of other users (friends) from a presence server 830 that is part of the mobile phone network infrastructure 820.

The messaging and calling applications are merely the software that allow the user to send and receive data such as e-mail, SMS, IM as well as the software for making and receiving voice calls. These applications are integrally linked with a contact database 280 that contains pertinent contact information for other users including telephone numbers, e-mail addresses, IM contact data, SMS contact data, etc. The location display application 260 is communicable with the messaging and calling applications 270 and the contact database 280 such that a friend identified by an icon on a map can be contacted using one of many modes of communication.

The presence server 830 that is part of the mobile phone network infrastructure 820 is responsible for maintaining location information for all portable mobile communications devices 100 that are subscribers. This data is then made available to other authorized users such that one user can plot the location of other users on a map to be displayed on their portable mobile communications device 100. Users can control whether their location data is made visible to other users.

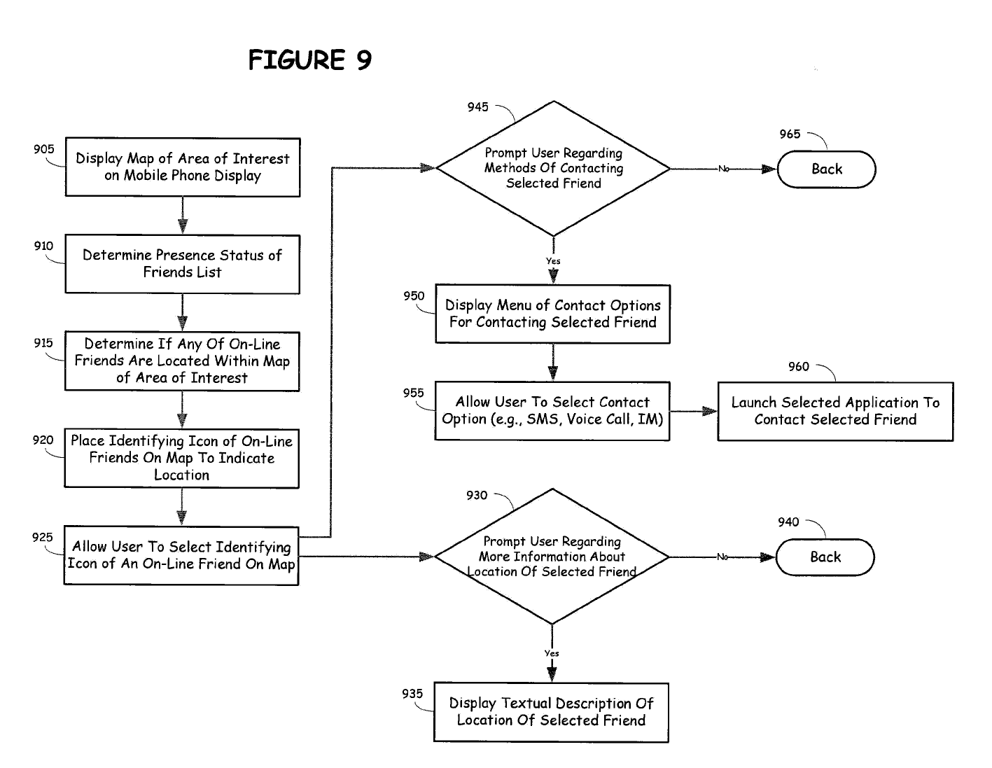

FIG. 9 is a flowchart illustrating a method for providing location information for selected users having similarly equipped portable mobile communications devices. In this embodiment the user selects an area and on-line friends are mapped to their locations within the selected area. In step 905, the user causes the portable mobile communications device via the user interface to display a map of an area of interest on the portable mobile communications device display. While that is occurring, the location display application is determining the presence (on-line) status of one or more other users (friends) having similarly equipped portable mobile communications devices in step 910.

In step 915, the location display application then determines if any on-line friends are located within the area defined by the map. This data is obtained via a request from an exchange of data between the portable mobile communications device and the presence server within the mobile phone network infrastructure. The presence server obtains, stores, and updates the location data of subscribing units. Each subscribing unit containing location determination means (i.e., GPS) periodically transmits this information back to the presence server within the mobile phone network infrastructure via the RF module. This location data is then made available to individual users upon verification of authorization. Authorization can take many forms that involve an individual user identifying other users (via their telephone number for instance) as having permission to view their location data. An individual user can also set a universal flag granting or denying access to location data to everyone. Or, a user can selectively grant access to location data to other users.

In step 920, the location display application places icons uniquely associated on-line friends on the map such that the user can visually determine the current location of any on-line friends within the area defined by the map.

In step 925, the user can navigate around the displayed map to highlight and select one of the displayed icons associated with another user (friend). Upon selection the user can be presented with options. In step 930, one option is to obtain more information about the location of the selected friend. If this option is selected the map on the portable mobile communications device display will be replaced with a textual or graphical (or both) description of the location as described in step 935. In step 945, another option is to determine if the user wishes to contact the friend associated with the location. If this option is selected the portable mobile communications device display will show a menu of contact options as described in step 950. These options include, but are not limited to, SMS, e-mail, IM, voice call, etc. In step 955, the user can select one of the contact options causing, in step 960, the portable mobile communications device to launch the appropriate application to establish the contact.

By knowing the location of the friend, the user can make an informed determination as to the best method of contact. For instance, if the location is a church the user may wish to delay contact or use a silent means such as text messaging. If the location is a grocery store, the user may wish to call and ask the friend to pick-up some groceries while they are there.

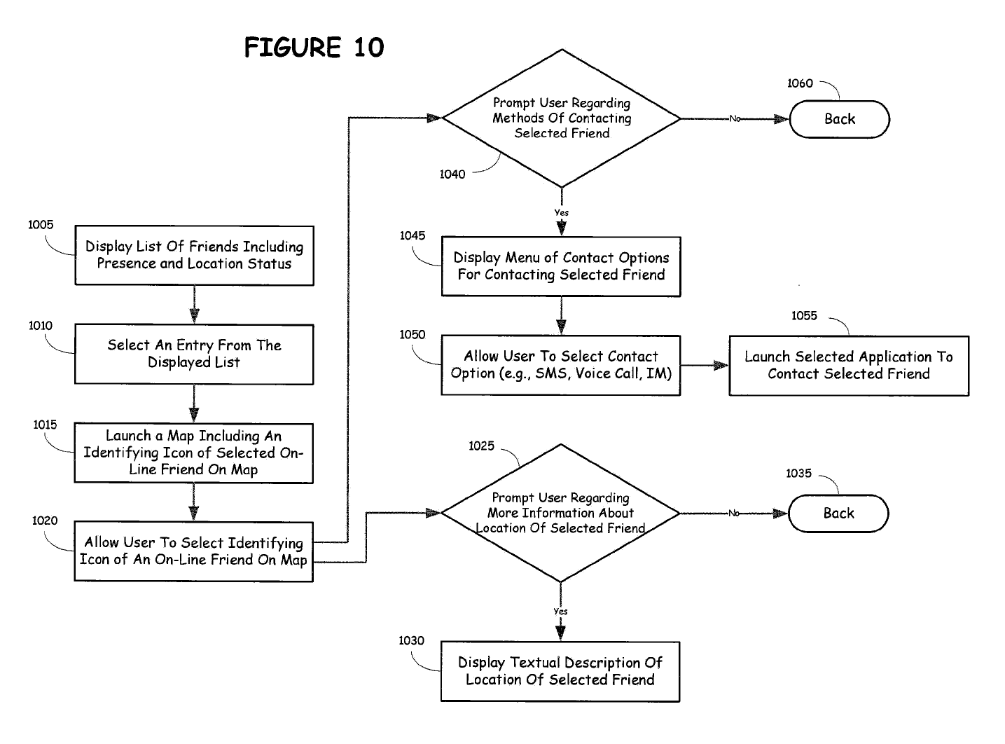

FIG. 10 is a flowchart illustrating an alternate method for providing location information for selected users having similarly equipped portable mobile communications devices. In this embodiment the user selects an on-line friend and requests a map of their location. In the prior embodiment the user was focused on an area while in this embodiment the user is focused on a friend. In step 1005, the user causes the portable mobile communications device to display a list of friends including their presence (on-line) status and a description of their location status. The user then navigates the list and selects one of the friends in step 1010 causing a map to be displayed in step 1015 containing a location icon for the selected friend on the map. In step 1020, the user can select the friend's location icon.

Upon selection the user can be presented with the options described with respect to FIG. 9 above. In step 1025, the option is to obtain more information about the location of the selected friend. If this option is selected the map on the portable mobile communications device display will be replaced with a textual or graphical (or both) description of the location as described in step 1030. In step 1040, the other option is to determine if the user wishes to contact the friend associated with the location. If this option is selected the portable mobile communications device display will show a menu of contact options as described in step 1045. these options include, but are not limited to, SMS, e-mail, IM, voice call, etc. In step 1050, the user can select one of the contact options causing, in step 1055, the portable mobile communications device to launch the appropriate application to establish the contact.

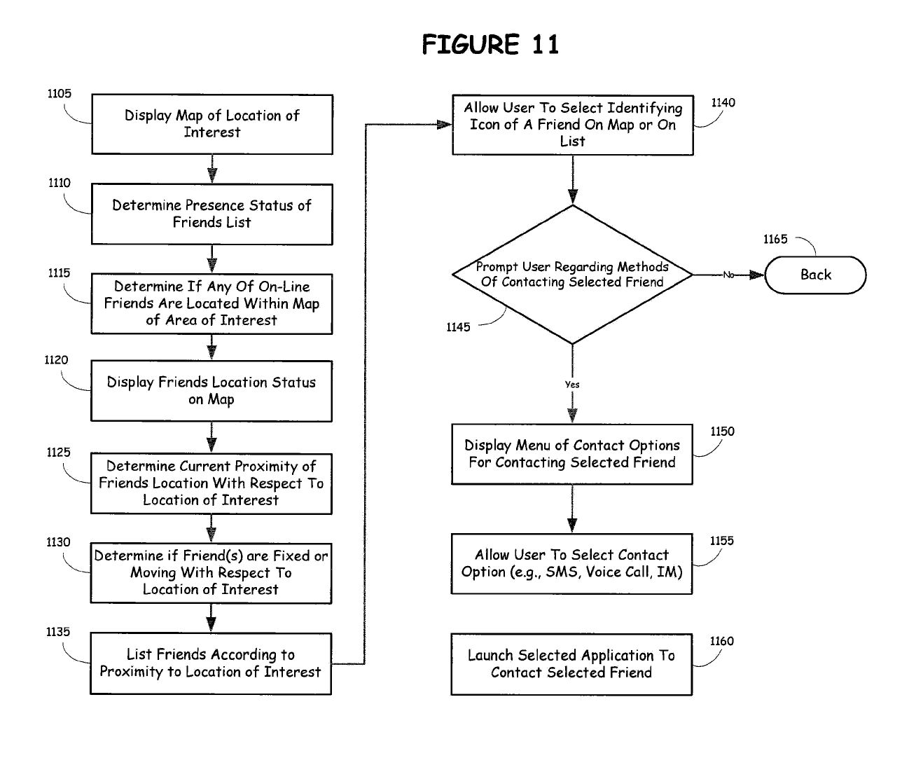

FIG. 11 is yet another flowchart illustrating an alternate method for providing location information for selected users having similarly equipped portable mobile communications devices. In this embodiment the user brings up a map of a location of interest and then ranks on-line friends according to their proximity to the location of interest. In step 1105, the user causes the portable mobile communications device via the user interface to display a map of an area of interest on the portable mobile communications device display. While that is occurring, the location display application is determining the presence (on-line) status of one or more other users (friends) having similarly equipped portable mobile communications devices in step 1110.

In step 1115, the location display application then determines if any on-line friends are located within the area defined by the map. This data is obtained via a request from an exchange of data between the portable mobile communications device and the presence server within the mobile phone network infrastructure. The presence server obtains, stores, and updates the location data of subscribing units. Each subscribing unit containing location determination means (i.e., GPS) periodically transmits this information back to the presence server within the mobile phone network infrastructure via the RF module. This location data is then made available to individual users upon verification of authorization. This step can be frequently repeated to determine whether the on-line friends are fixed at a location or moving in a certain direction at a certain rate.

In step 1120, the location display application places icons uniquely associated on-line friends on the map such that the user can visually determine the current location of any on-line friends within the area defined by the map as well as their heading and speed. In step 1125, the location display application determines the current proximity of each on-line friend's location with respect to the location of interest. In step 1130, the location display application determines whether each on-line friend is currently moving or in a fixed location. This information can be plotted on the map and associated with a friend's icon using a directional arrow or the like. In step 1135, the current proximity information is used to construct a list of on-line friends that is ranked according to their proximity to the location of interest. This allows the user to select a friend to contact that is closest to the location of interest. Or, the user can select a friend to contact that is heading in the direction of the location of interest.

In step 1140, the user can navigate around the displayed map or the ranked priority list to highlight and select one of the displayed icons associated with another user (friend). In step 1145, the user is prompted whether they wish to contact the friend associated with the location. If this option is selected the portable mobile communications device display will show a menu of contact options as described in step 1150. In step 1155, the user can select one of the contact options causing, in step 1160, the portable mobile communications device to launch the appropriate application to establish the contact.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Any prompts associated with the present invention may be presented and responded to via a graphical user interface (GUI) presented on the display of the portable mobile communications device or the like.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. On a portable mobile communications device, a method of providing location data of other portable mobile communications devices as icons on a map display, the method comprising:
displaying a map on the display;
determining the on-line presence status of one or more other portable mobile communications devices associated with users;
obtaining geographical location data of the one or more other portable mobile communications devices that are currently on-line; and
inserting an icon for each of the one or more other portable mobile communications devices that are currently on-line on the displayed map such that each icon is placed on the map so as to accurately represent the actual geographic location of each of the one or more other portable mobile communications devices.

2. The method of claim 1 further comprising:
selecting an icon on the map; and
changing the display of the portable mobile communications device to show additional data pertaining to the geographic location represented by the icon in response to the selection of the icon;

3. The method of claim 1 further comprising:
selecting an icon on the map; and
changing the display of the portable mobile communications device to present one or more options for contacting the other portable mobile communications device represented by the icon in response to the selection of the icon.

4. The method of claim 3 further comprising:
selecting an option for contacting the other portable mobile communications device represented by the icon; and
launching an application to carry out the selected option for contacting the other portable mobile communications device represented by the icon.

5. The method of claim 3 wherein one of the options for contacting the other portable mobile communications device represented by the icon is an SMS text message.

6. The method of claim 3 wherein one of the options for contacting the other portable mobile communications device represented by the icon is an e-mail message.

7. The method of claim 3 wherein one of the options for contacting the other portable mobile communications device represented by the icon is a voice call.

8. The method of claim 3 wherein one of the options for contacting the other portable mobile communications device represented by the icon is an instant message (IM).

9. The method of claim 3 wherein one of the options for contacting the other portable mobile communications device represented by the icon is a push-to-talk connection.

10. The method of claim 1 further comprising:
changing the display of the portable mobile communications device to show a list of the one or more other portable mobile communications devices associated with users that have an on-line presence status.

11. The method of claim 10 further comprising:
ranking the list of the one or more other portable mobile communications devices associated with users that have an on-line presence status according to their proximity to a location of interest.

12. The method of claim 11 wherein the list ranking of the one or more other portable mobile communications devices associated with users based on their proximity to a location of interest goes from closest to furthest.

13. A computer program product embodied on a computer readable medium for providing location data of other portable mobile communications devices as icons on a map display, the computer program product comprising:
computer program code for displaying a map on the display;
computer program code for determining the on-line presence status of one or more other portable mobile communications devices associated with users;
computer program code for obtaining geographical location data of the one or more other portable mobile communications devices that are currently on-line; and
computer program code for inserting an icon for each of the one or more other portable mobile communications devices that are currently on-line on the displayed map such that each icon is placed on the map so as to accurately represent the actual geographic location of each of the one or more other portable mobile communications devices.

14. The computer program product of claim 13 further comprising:
computer program code for selecting an icon on the map; and
computer program code for changing the display of the portable mobile communications device to show additional data pertaining to the geographic location represented by the icon in response to the selection of the icon;

15. The computer program product of claim 13 further comprising:
computer program code for selecting an icon on the map; and
computer program code for changing the display of the portable mobile communications device to present one or more options for contacting the other portable mobile communications device represented by the icon in response to the selection of the icon.

16. The computer program product of claim 15 further comprising:
computer program code for selecting an option for contacting the other portable mobile communications device represented by the icon; and
computer program code for launching an application to carry out the selected option for contacting the other portable mobile communications device represented by the icon.

17. The computer program product of claim 15 wherein one of the options for contacting the other portable mobile communications device represented by the icon is an SMS text message.

18. The computer program product of claim 15 wherein one of the options for contacting the other portable mobile communications device represented by the icon is an e-mail message.

19. The computer program product of claim 15 wherein one of the options for contacting the other portable mobile communications device represented by the icon is a voice call.

20. The computer program product of claim 15 wherein one of the options for contacting the other portable mobile communications device represented by the icon is an instant message (IM).

21. The computer program product of claim 15 wherein one of the options for contacting the other portable mobile communications device represented by the icon is a push-to-talk connection.

22. The computer program product of claim 13 further comprising:
computer program code for changing the display of the portable mobile communications device to show a list of the one or more other portable mobile communications devices associated with users that have an on-line presence status.

23. The computer program product of claim 22 further comprising:
computer program code for ranking the list of the one or more other portable mobile communications devices associated with users that have an on-line presence status according to their proximity to a location of interest.

24. The computer program product of claim 23 wherein the computer program code for list ranking of the one or more other portable mobile communications devices associated with users based on their proximity to a location of interest goes from closest to furthest.

25. A portable mobile communications device for providing location data of other portable mobile communications devices as icons on a map display comprising:
a processor;
a location display application executable by the processor;
an RF module for communicating with a mobile phone network infrastructure;
a display for presenting map data; and
a user interface for navigating and manipulating the location display application,
wherein the location display application can be instructed via the user interface to obtain the locations of other portable mobile communications devices from the mobile phone network infrastructure via the RF module such that the locations of the other portable mobile communications devices can be plotted as uniquely identifiable icons on the display in conjunction with the map data to yield a graphical indication of where the other portable mobile communications devices are currently located.

26. The portable mobile communications device of claim 25 further comprising a map database stored locally on the portable mobile communications device.

27. The portable mobile communications device of claim 25 further comprising a contact database stored locally on the portable mobile communications device, the contact database containing data pertaining to the other portable mobile communications devices.

28. The portable mobile communications device of claim 25 further comprising messaging applications that can be launched upon the selection of an icon from the map display.

29. The portable mobile communications device of claim 25 further comprising calling applications that can be launched upon the selection of an icon from the map display.
